(19) United States
(12) Patent Application Publication
(10) Pub. No.: US 2009/0264027 A1
(43) Pub. Date: Oct. 22, 2009

(54) CONNECTION TERMINAL AND LOW-VOLTAGE ELECTRICAL APPLIANCE

(75) Inventor: ARIEL RUIZ, VILLEURBANNE (FR)

Correspondence Address: CANTOR COLBURN, LLP, 20 Church Street, 22nd Floor, Hartford, CT, 06103, US

(73) Assignee: ABB FRANCE, RUEIL-MALMAISON (FR)

(21) Appl. No.: 12/428,193

(22) Filed: Apr. 22, 2009

(30) Foreign Application Priority Data
Apr. 22, 2008 (FR) 08/02244

(51) Int. Cl. H01R 4/48

(52) U.S. Cl. 439/861

(57) ABSTRACT

The invention relates to a connection terminal for the connection of an electrical conductor, comprising a conducting connecting strip and a clamping spring, the spring comprising a bearing branch connected by an elbow to a clamping branch designed to clamp the conductor against a clamping portion of the strip, the strip having a first surface facing the elbow of the spring and a second surface opposite the first surface. The spring comprises at least one bearing hook designed to bear on the second surface of the strip opposite the first surface of the strip facing the elbow of the spring.

### FIELD OF THE INVENTION

The present invention relates to a connection terminal and a low-voltage electrical appliance comprising such a terminal.

### BACKGROUND OF THE INVENTION

A connection terminal for the connection of an electrical conductor is well known, comprising a conducting connecting strip and a clamping spring, the spring comprising a bearing branch connected by an elbow to a clamping branch designed to clamp the conductor against a clamping portion of the strip, the strip having a first surface facing the elbow of the spring and a second surface opposite the first surface.

These arrangements are satisfactory in that they allow the electrical conductor to be clamped and held in position in contact with the strip.

The specific shape of a housing in an insulating body of an electrical appliance that receives the terminal can ensure that the spring is held in position with respect to the strip. In this case, it is advisable to fit the strip on the one hand and the spring on the other separately in the body of the appliance, and this complicates the manufacture of the appliance.

Producing a specific shape of the strip to form a housing for the bearing branch can also ensure that the spring is held in position with respect to the strip. In this case, the strip has a tailored profile which complicates its manufacture and involves the use of a larger quantity of metal in order to produce the strip.

The present invention solves all or some of the abovementioned drawbacks.

### SUMMARY OF THE INVENTION

To this end, one subject of the present invention is an appliance of the abovementioned type, characterized in that the spring comprises at least one bearing hook oriented transversely to the plane of the bearing branch, extending with respect to this plane in the opposite direction to the clamping branch and bearing on the second surface of the strip opposite the first surface of the strip facing the elbow of the spring.

The arrangements according to the invention make it possible to hold the spring in position on the strip by contacting the clamping portion of the strip with the clamping branch of the spring on the one hand, and by contacting the bearing hook or hooks with the second surface of the strip on the other.

This holding in position is brought about without the need for a complex strip profile.

Advantageously, the hook passes through the plane of the strip at an opening in the latter.

These arrangements make it possible to limit the width of the assembly of spring and strip, which remains the same as the width of the strip.

According to one embodiment, the opening in the strip is in the form of a lateral notch.

These arrangements allow the opening in the strip to be produced simply.

According to one possibility, the strip comprises two lateral notches on the two opposite side edges of the strip, the spring comprising two lateral bearing hooks designed to pass respectively through the plane of the strip at the two notches.

These arrangements provide improved stability of the spring with respect to the strip.

According to one embodiment, the at least one bearing hook is obtained by bending the bearing branch.

According to another possibility, the strip comprises a through-opening that does not open onto the side edges of the strip, the spring comprising a hook designed to pass through the plane of the strip via this opening.

Advantageously, the strip comprises means that form an end stop for the clamping branch of the strip in the contact zone between the clamping branch and the strip in the rest position of the terminal.

These arrangements make it possible to hold the spring better on the strip.

According to one embodiment, the end stop consists of a notch in the strip.

According to one possibility, the clamping portion of the conductor on the strip consists of the wall of an opening in the strip.

Advantageously, the wall of the opening comprises a collar.

These arrangements make it easier in particular to guide the conductor in the opening.

According to another possibility, the clamping portion of the conductor on the strip is produced at a portion of the strip that is bent with respect to the portion of the strip on which the bearing branch of the spring bears.

According to one possibility, the hook of the spring is connected to the bearing branch by an edge bent about a bending axis substantially parallel to the axis of the bearing branch.

According to another possibility, the hook of the spring forms a curved portion in line with the bearing branch.

Another subject of the present invention is an electrical appliance comprising an insulating body and at least one connection terminal as described hereinabove.

### BRIEF DESCRIPTION OF THE DRAWINGS

The invention will be better understood with the aid of the following detailed description in conjunction with the attached drawing, in which:

FIG. 1 is a partial sectional view of a first terminal according to the invention in an electrical appliance;

FIG. 2 is a view from above of a strip for the terminal in FIG. 1;

FIG. 3 is a front view of a spring for the terminal in FIG. 1;

FIG. 4 is a perspective view of the spring in FIG. 3; and

FIG. 5 is an exploded perspective view of a detail of a second terminal according to the invention.

### DETAILED DESCRIPTION OF THE PREFERRED EMBODIMENTS

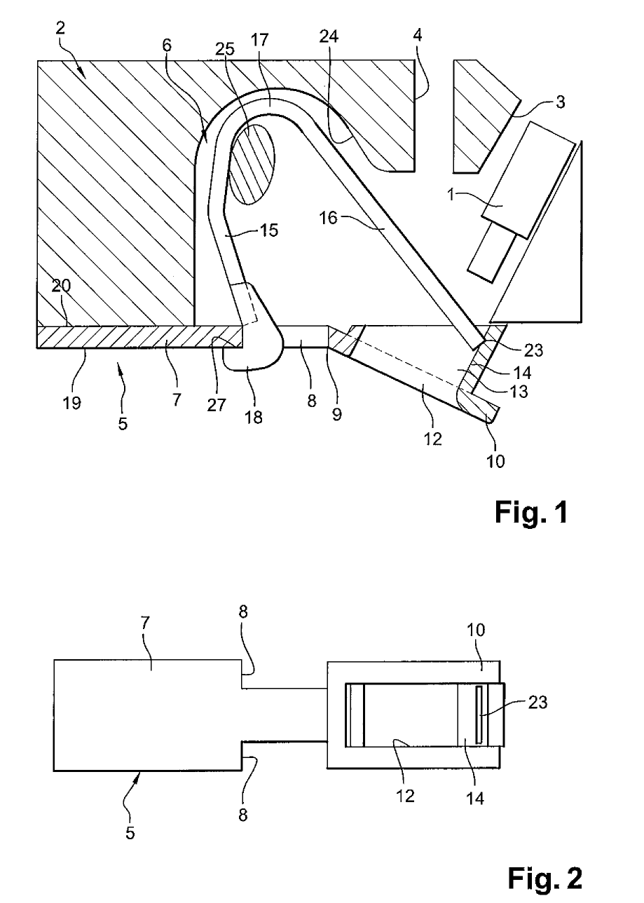

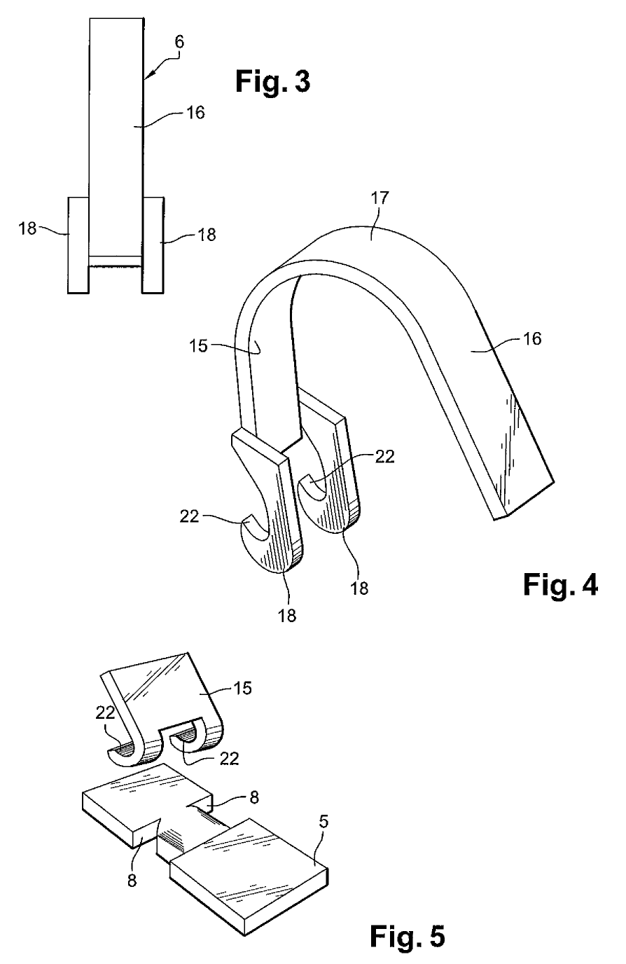

According to a first embodiment shown in FIGS. 1 to 4, a connection terminal for the connection of an electrical conductor 1 is received in a housing of the insulating body 2 of a low-voltage electrical appliance.

The insulating body 2 comprises an opening 3, for introducing a conductor, that opens into the terminal housing.

The insulating body 2 also comprises an opening 4 that opens into the terminal housing and is provided for the introduction of a tool for removing the conductor 1.

The terminal comprises a conducting connecting strip 5 and a clamping spring 6.

The connecting strip 5 comprises a first straight portion 7 in which, on either side of this strip 5, two opposing lateral notches 8 are formed which constitute two first openings passing through the strip 5, these two openings 8 opening onto the side edges of the strip 5.

The strip also comprises a bend 9 and a second portion 10 inclined with respect to the first portion. A third central opening 12 is formed in the strip at the second portion.

This opening is a through-opening and is formed by punching through the strip from the lower surface thereof so as to form a collar 13 around the opening 12. The generatrices of this collar 13 are substantially parallel to the axis of the opening 3 for introducing the conductor 1. These arrangements make it easier to guide the conductor 1 in the opening 12.

It should be noted that the combination of the bend 9 in the strip and the production of a straight punch from the lower surface of the strip makes it easier to produce the guiding collar without having to punch along an oblique axis with respect to the surface to be punched.

The wall of the collar 13 constitutes a clamping portion 14 of the strip 5 against which the conductor 1 is pressed by the spring 6.

The spring 6 comprises a bearing branch 15 and a clamping branch 16 for the conductor 1.

The clamping branch 16 and the bearing branch 15 are connected by an elbow 17.

The clamping branch 16 is designed to clamp the conductor 1 against the clamping portion 14 of the strip.

The bearing branch 15 is extended by bending by means of bearing hooks 18 designed to bear against the lower surface 19 of the strip 5 opposite the surface 20 of the strip 5 facing the elbow 17 of the spring.

These hooks 18 are oriented transversely to the plane of the bearing branch 15 and extend with respect to this plane in the opposite direction to the clamping branch 16.

The hooks 18 are produced by cutting and bending about a bending axis substantially parallel to the axis of the bearing branch 15.

Each bearing hook 18 passes through the strip 5 respectively via one of the two openings or lateral notches 8 and comes into contact with the lower surface 19 of the strip by means of a bearing zone 22.

The strip 5 comprises, at the clamping portion 13 of the strip 5, a notch 23 constituting an end stop for the end of the clamping branch 16 of the spring 6 at the contact zone between the clamping branch 16 and the strip 5 in the rest position of the terminal, i.e. when no conductor is connected thereto.

The housing 24 of the terminal in the insulating body of the electrical appliance has a profiled wall outside the elbow of the spring and a guiding finger 25 designed to be positioned inside the elbow 17 of the spring 6, between the bearing branch 15 and the clamping branch 16.

It should be noted that the shape and spring rate of the spring 6 make it possible to introduce the conductor 1 counter to the force of the spring without using a tool.

According to a second embodiment shown partially in FIG. 5, the hooks 18 are produced by cutting and bending about a bending axis transverse to the axis of the bearing branch 15.

Furthermore, the lateral notches 8 in the strip are produced by cutting and bending the first portion of the strip 5.

According to one variant that is not shown, the strip is not bent between the first and second portions, the profile of the strip being straight.

According to another variant that is not shown, the first portion of the strip comprises a through-opening that does not open onto the side edges of the strip, the spring comprising a hook designed to pass through the plane of the strip via this opening.

According to another variant that is not shown, the clamping portion of the strip consists of a portion bent with respect to the first portion and not of a punched opening.

Although the invention has been described in connection with particular embodiments, it is clear that it is in no way limited thereto and that it comprises any technical equivalents of the means described as well as combinations thereof, as long as the latter are within the scope of the invention.

1. Connection terminal for the connection of an electrical conductor, comprising a conducting connecting strip and a clamping spring, the spring comprising a bearing branch connected by an elbow to a clamping branch designed to clamp the conductor against a clamping portion of the strip, the strip having a first surface facing the elbow of the spring and a second surface opposite the first surface, the spring comprises at least one bearing hook oriented transversely to a plane of the bearing branch, extending with respect to this plane in opposite direction to the clamping branch and bearing on the second surface of the strip opposite the first surface of the strip facing the elbow of the spring.

2. Connection terminal according to claim 1, wherein the bearing hook passes through the plane of the strip at an opening in the latter.

3. Connection terminal according to claim 2, wherein the opening in the strip is in the form of a lateral notch.

4. Connection terminal according to claim 3, wherein the strip comprises two lateral notches on two opposite side edges of the strip, the spring comprising two lateral bearing hooks designed to pass respectively through the plane of the strip at the two notches.

5. Connection terminal according to claim 1, wherein the at least one bearing hook is obtained by bending the bearing branch.

6. Connection terminal according to claim 2, wherein the strip comprises a through-opening that does not open onto side edges of the strip, the spring comprising a hook designed to pass through the plane of the strip via this opening.

7. Connection terminal according to one of the preceding claims, the strip comprises means that form an end stop for the clamping branch of the strip in contact zone between the clamping branch and the strip in a rest position of the terminal.

8. Connection terminal according to claim 7, wherein the end stop consists of a notch in the strip.

9. Connection terminal according to claim 2, wherein the clamping portion of the conductor on the strip consists of a wall of an opening in the strip.

10. Connection terminal according to claim 9, wherein the wall of the opening comprises a collar.

11. Connection terminal according to claim 1, the clamping portion of the conductor on the strip is produced at a portion of the strip that is bent with respect to a portion of the strip on which the bearing branch of the spring bears.

12. Connection terminal according to claim 1, wherein the hook of the spring is connected to the bearing branch by an edge bent about a bending axis substantially parallel to an axis of the bearing branch.

13. Connection terminal according to claim 1, wherein the hook of the spring forms a curved portion in line with the bearing branch.

14. Low-voltage electrical appliance comprising an insulating body and at least one connection terminal according to claim 1.
